(19) United States
(12) Patent Application Publication
(10) Pub. No.: US 2018/0222741 A1
(43) Pub. Date: Aug. 9, 2018

(54) VEHICLE DRIVE AWAY PREVENTION

(71) Applicant: DOPS PROJECT PTY LTD, Subiaco, Western Australia (AU)

(72) Inventors: Wayne Bernard COX, Baldivis (AU); Warren John OATES, Golden Bay (AU); Johnny GERVOE, Bicton (AU)

(21) Appl. No.: 15/748,143

(22) PCT Filed: Jul. 8, 2016
(86) PCT No.: PCT/AU2016/050601

§ 371 Date: Jan. 26, 2018

(30) Foreign Application Priority Data
Jul. 8, 2015 (AU) 2015902702

(51) Int. Cl. B67D 7/06

(52) U.S. Cl. CPC B67D 7/065

(57) ABSTRACT

A vehicle drive away prevention system (10,100) and method includes at least one vehicle drive away prevention apparatus (11,110) selectively allowing or preventing/restricting a vehicle leaving a holding zone. The apparatus has at least one detection means (18,118) for detecting at least one parameter indicative of movement or anticipated movement of the vehicle within the holding zone, and control means responsive to the at least one detection means to control operation of the vehicle drive away pre venter apparatus to prevent the vehicle from leaving the holding zone (14) when the at least one detection means (18,118) detects the at least one parameter indicative of actual movement or anticipated movement of the vehicle. One or more barriers (26,126) can be deployed in front of and/or behind a wheel of the vehicle if attempted or suspected vehicle drive away is detected.

### FIELD OF THE INVENTION

The present invention relates to vehicle drive away prevention.

Particularly, though not solely, the present invention relates to mitigation of fuel theft by preventing vehicles from driving away from service stations or electricity recharging stations.

One or more forms of the present invention will hereinafter be referred to in relation to preventing vehicles from being driven away where fuel is obtained without pre or post-fill payment.

In this specification, the term ‘fuel’ includes liquid fuels, such as gas/petrol and diesel (derv), liquefied gas fuel (such as propane and/or butane and mixes thereof, or liquefied hydrogen fuel), and electricity for rechargeable electric vehicles. As such, electrical energy or electrical charge is considered fuel within the scope and meaning of this specification.

Furthermore, reference to fuel pump or fuel bowser etc., is also deemed to include electric vehicle electricity recharging stations and related equipment for charging an electric vehicle.

Electric vehicles are deemed to include rechargeable battery vehicles.

It is to be understood that one or more forms of the present invention is/are suitable for other applications where drive away prevention is required, such as at security gates or other security checkpoints.

### BACKGROUND TO THE INVENTION

Service stations (also known as petrol or gas stations) have a problem whereby persons drive away from a forecourt or bowser (fuel or gas pump) without having prepaid or post-paid for the fuel they have put into their vehicle. Essentially, stealing the fuel.

Some drivers may drive away simply having forgotten to pay, distracted by persons and/or pets with the vehicle or becoming occupied by another task, such as cleaning the windscreen or checking tyres.

Other drivers may think or believe that the fuel has been paid for, such as by another person (e.g. a friend or relative) indicating that they have paid by credit or debit card, and that payment has not been successful or not actioned. The driver unintentionally or being duped into driving away without paying.

Other drivers intentionally drive away without paying for the fuel—essentially, outright theft of fuel.

Many service stations have minimal, if any, procedures and systems to prevent fuel theft (intentional theft or unintentional theft).

Closed circuit camera systems have been used to record footage of vehicle and people movements at service stations. If a vehicle drive away without paying for the fuel is suspected or identified by the service station operator(s), the recorded footage can be reviewed in the hope or expectation of identifying the vehicle license plate and/or the perpetrator. However, such reviewing of recorded footage does not prevent the drive away fuel theft.

Such ‘drive-off’ or ‘drive away’ offences are considered a breach of contract rather than a criminal offence, since buying the fuel is an agreement between the service station operator and the consumer. Thus, excuses of forgetting to pay for the fuel result in minimal punishment or other reasons not to ‘re-offend’, aside from reimbursing the station the amount owed and a possible nominal fine. There is no criminal act and therefore no criminal punishment, such as risk of imprisonment or large fine to dissuade offenders or re-offenders.

Some service stations use a simple method of handwriting the car registration number if a driver drives away from the forecourt without paying for the fuel. This relies on the attendant remembering to write down every license plate number, even during busy periods when it is easy to forget or be under pressure to serve customers.

Some service stations require the attendants to repay the value of the stolen fuel from wages if they have not noted the license plate number. This places an unfair burden on attendants and can lead to poor staff retention and dissatisfaction.

One solution to the problem of fuel theft has been proposed in US published patent document US 2014/0236444 A1, in which a vehicle emergency operating mode is enabled during refuelling until the fuel is paid for. The emergency operating mode includes, for example, limiting the maximum speed of the vehicle. Such a solution not only requires a system to be installed at the refuelling point but also requires integration between the vehicle's systems and the system at the refuelling point. This is a relatively complex system to adopt and requires either OEM or at least aftermarket integration with vehicle systems, which may require legislative changes to make practical.

Another solution to the problem of fuel theft has been proposed in Australian published patent document AU 2014100772 A1 which describes a vehicle credit history based on previous (positive) payments for fuel and previous (negative) non-payments for fuel. An attendant has the ability to prevent or allow fuel fill based on the credit history.

At least one system of mitigating drive away fuel theft is provided by a camera arrangement that can record the license plate of each vehicle attending a fuel pump. Such a system, if it works at all, will provide an image of the license plate that can be used for identification purposes (such as by the police investigating the fuel theft), but it does not readily help to identify repeat offenders who may go to a different service station or where the attendant does not have time to compare many license plate images with the license plates on the forecourt or compare a recently obtained license plate image from a recent drive-away with previous images.

Also, if the license plate is a false license plate, put onto the vehicle for the purpose of obtaining fuel without paying, a camera system will not be able to identify the genuine license plate and owner of the vehicle.

Prepayment at the pump technology has been rolled out to many service stations. However, unless mandated by the service station, many patrons do not use the prepayment at the pump option and prefer to pay for the fuel within the service station. This also gives the patron an opportunity to shop within the store area of the service station, generating valuable income for many service station operators and chains. Consequently, prepayment at the pump is often not preferred by patrons or service station operators.

It is with such problems in mind that the present invention has been developed.

It has been found desirable to provide an apparatus, system and/or method of mitigating drive-away fuel theft that improves recognition of a vehicle used in a drive-away fuel theft.

It has been found further desirable to provide a system and/or method of preventing drive-away fuel theft that physically prevents the vehicle from being driven away without payment for the fuel or authorisation.

Furthermore, it is alternatively or additionally desirable to provide a system and/or method of preventing drive-away fuel theft that does not disrupt normal fuel dispensing and payment practices.

### SUMMARY OF THE INVENTION

With the aforementioned in mind, an aspect of the present invention provides a vehicle drive away prevention system including:

at least one vehicle drive away prevention apparatus to selectively allow the vehicle to leave a holding zone or prevent the vehicle from leaving the holding zone,
at least one detection means for detecting at least one parameter indicative of movement or anticipated movement of the vehicle within the holding zone, and
control means responsive to the at least one detection means to control operation of the vehicle drive away preventer apparatus to prevent the vehicle from leaving the holding zone when the at least one detection means detects the at least one parameter indicative of actual movement or anticipated movement of the vehicle.

The vehicle drive away prevention apparatus may include one or more rotatable surfaces, such as provided by one or more rollers. For example, the powered (driven) wheels of the vehicle may rest on or be supported by one or more respective rollers within the holding zone. If drive is applied to the wheels in an attempt to drive away, the roller(s) may either be powered or freewheel in contact with the vehicle's wheels and prevent the drive away. The vehicle will, essentially, spin its wheels without substantial forward or rearward movement.

The roller(s) may be provided in a respective well, or the vehicle's powered (driven) wheels may be lifted clear of the ground surface to prevent any traction (grip) of the vehicle's tyres on the ground surface.

A further aspect of the present invention provides a vehicle drive away prevention system including:

at least one barrier deployable to prevent the vehicle from leaving a holding zone,
at least one barrier actuator to deploy the at least one barrier,
at least one detection means for detecting at least one parameter indicative of movement or anticipated movement of the vehicle within the holding zone, and
a control means to control the at least one actuator to deploy the at least one barrier,
the control means allowing the at least one barrier actuator to deploy the barrier to prevent the vehicle from leaving the holding zone when the at least one detection means detects the at least one parameter indicative of actual movement or anticipated movement of the vehicle.

Advantageously, it will be appreciated that the at least one barrier is not deployed unless the at least one parameter is detected. For example, a physical event, a control condition, a threshold value, a threshold event, or combination of two or more thereof, may be detected and therefore the at least one barrier is deployed to prevent vehicle drive away.

Therefore, for example, if payment for fuel is received before an attempt is made to drive the vehicle away, the barrier need not be deployed.

On the other hand, if payment is not received after fuel has been put into the vehicle, and an attempt is made to drive away without paying for the fuel, the at least one barrier will be deployed and the vehicle hindered from departing.

The control condition may be that the vehicle is to be prevented from leaving the holding zone. Preferably, the control condition may include at least one signal or absence of the at least one signal relating to non-payment of fuel prior to the vehicle attempting to leave the holding zone.

The vehicle drive away prevention system, wherein the at least one control condition signal relates to one or more of a fuel payment system, fuel delivery control system indicating that fuel has not been paid for and the vehicle is to be prevented form leaving the holding zone.

Preferably the vehicle drive away prevention system includes at least one vehicle presence detection means to detect presence of the vehicle within the holding zone. One or more signals from the at least one vehicle presence detection means may be utilised to enable at least one fuel delivery system to provide fuel for the vehicle.

For example, detecting presence of the vehicle may be used to enable activation of a fuel pump or electricity charging station. Such activation may be by providing an indication to an operator to enable activation of the fuel delivery system or may activate the fuel delivery system (and optionally notify the operator that the fuel delivery system has been activated). A patron/customer may then commence delivery of fuel to the vehicle—for example, by inserting the pump nozzle into the vehicle's fuel filler and operating the fuel pump nozzle trigger.

The at least one vehicle presence sensor may act as the respective at least one vehicle movement sensor.

A manual override system can be implemented to allow deactivation (for example, lowering) of the barrier(s).

For example, such manual override to deactivate (e.g. lower) the barrier(s) may be provided in case of failure of the normal operation or control of the system, power failure or other loss of function to the system.

A manual override function may instead or also be included to allow the barrier(s) to be deployed at the discretion on the operator or other authorised person.

Therefore, at least one manually controlled activation means may be provided to cause the at least one actuator to deploy the at least one barrier to hinder or prevent vehicle drive away when vehicle drive away is anticipated but a condition has not yet been met, or a said parameter has not yet been detected, by the detection means.

For example, the at least one manually controlled activation means may include a manual override control accessible to a person, such as a service station operator or other authorised personnel (for example, police or fire service personnel), to activate deployment of the at least one barrier.

In addition, or alternatively, at least one manually controlled deactivation means may be provided to cause the deployed at least one barrier to retract to allow the vehicle to depart the holding zone.

For example, the at least one manually controlled deactivation means may include a manual override control accessible to a person, such as a service station operator or other authorised personnel (for example, police or fire service personnel).

Manual override control for causing deployment and/or retraction of the at least one barrier may include, for example, a physical manual control and/or a graphical user interface (GUI) control panel override (such as, for example, an emergency manual override switch or button).

Alternatively, or in addition, the manual override control may include ant least one audio detector for voice activation by an authorised person to control deployment and/or retraction of the at least one barrier.

At least one said barrier may be deployed ahead of at least one wheel to prevent the vehicle driving forwards out of the holding zone or at least one barrier may be deployed behind the at least one wheel of the vehicle to prevent the vehicle reversing out of the holding zone.

The at least one barrier may be deployed proximate the at least one wheel so at to act on the wheel to prevent the vehicle departing the holding zone. This reduces the amount of momentum that the vehicle can build before striking the at least barrier and avoid or minimise any damage to the vehicle and/or to the barrier(s) and actuator(s).

Alternatively, at least one barrier member may be deployed ahead of the at least one wheel to prevent the vehicle driving forwards out of the holding zone and at least one other barrier may be deployed behind the at least one, or another, wheel of the vehicle to prevent the vehicle reversing out of the holding zone.

In such embodiments of the system, the barrier(s) may be deployed proximate the respective at least one wheel, or proximate the at least one and another wheel, so at to act respectively on the or both wheels to prevent the vehicle departing the holding zone. This reduces the amount of momentum that the vehicle can build before striking the at least one and the at least one other barrier and avoid or minimise any damage to the vehicle.

The holding zone may include at least one well or recess for receiving a respective at least one wheel of the vehicle.

The at least one barrier actuator may include at least one pneumatic ram, hydraulic ram or electric actuator, or combinations of two or more thereof.

Preferably, the barrier actuator includes at least one link device connecting the respective actuator ram or electric actuator to at least one deployable barrier member.

The drive away prevention system may include a support surface to support a vehicle.

Preferably the support surface includes the holding zone.

Preferably the support surface may be provided as part of an assembly or unit for installation at, for example, a service station. Preferably the assembly or unit incorporates the at least one barrier actuator.

A further aspect of the present invention provides a vehicle drive away prevention method including:

employing at least one detection means to detect at least one parameter indicative of movement or anticipated movement of the vehicle within a holding zone,
operating a vehicle drive away preventer apparatus to prevent the vehicle from leaving the holding zone when the at least one detection means detects the at least one parameter indicative of actual movement or anticipated movement of the vehicle.

One or more forms of the present invention may include providing a method of preventing vehicle drive away from a holding zone, the method including the steps of:

a) providing at least one deployable barrier;
b) determining that a vehicle is attempting to depart or is anticipated to attempt to depart from the holding zone; and
c) deploying the at least one barrier to prevent departure of the vehicle from the holding zone.

Preferably the at least one barrier is deployed when a condition to allow the vehicle to depart the holding zone has not been met.

Alternatively, the at least one barrier is deployed when a condition to prevent the vehicle departing the zone has been met.

Preferably, the condition to allow the vehicle to depart the holding zone or the condition to prevent the vehicle departing is payment of fuel or confirmation of payment of fuel or an authorisation.

Preferably, detecting that the vehicle is attempting to depart the holding zone or is anticipated as likely to depart the holding zone includes detecting movement of the vehicle and/or movement of one or more components of the vehicle (such as vibration of the exhaust/muffler system, operation of the engine, vibration or movement of the chassis or bodywork).

Vehicle movement and/or vibration detection may include one or more of rotation of one or more wheels of the vehicle, forward or rearward movement of one or more wheels of the vehicle, movement of the vehicle body, movement of the vehicle chassis, or ancillary components of the vehicle, detection of engine start-up or attempt to start-up, driver returning the driver's seat, or a combination of two or more thereof.

Determining that the vehicle is or is anticipated as likely to attempt to depart the holding zone may include detection of a thermal parameter, such as a heat characteristic of the vehicle's engine or exhaust/muffler and/or heat signature of a driver or other person returning to the vehicle.

If a vehicle stops within the holding zone and no fuel is dispensed at that holding zone, the at least one barrier may regardless be deployed if a condition is met, such as manual activation of the at least one barrier, for example, if theft or under-payment or suspected theft or under-payment of goods occurs, such as from a service station store.

Preferably, the condition to be met is provided from one or more of a fuel delivery control system or fuel payment system, or a combination of the fuel delivery control system and the fuel payment system.

It will be appreciated that the system and/or method according to one or more embodiments of the present invention may be considered a passive system in the sense that the barrier to prevent departure of the vehicle is not actively and automatically deployed when the vehicle stops in the holding zone.

According to one or more embodiments, no barrier is deployed until, for example, fuel is put into the vehicle and an attempt is made to drive away without paying. In such instances, if an attempt is made to move the vehicle as if to drive away without paying for the fuel, the barrier(s) is/are deployed to prevent the vehicle driving away until payment for fuel is made or the vehicle is otherwise authorised to depart.

The at least one barrier may be deployed:
i) ahead of at least one wheel of the vehicle to prevent the vehicle driving forwards out of the holding zone, or
ii) behind the at least one wheel or another wheel of the vehicle to prevent the vehicle reversing out of the holding zone, or
iii) ahead of the at least one wheel to prevent the vehicle driving forwards out of the holding zone and behind the at least one wheel or another wheel of the vehicle to prevent the vehicle reversing out of the holding zone.

Preferably, presence of the vehicle within the holding zone is detected. Such detected presence may be used to enable delivery of fuel to the vehicle.

Preferably the or each barrier is deployed to be a distance above the ground to prevent, for example, the vehicle mounting or “climbing” over the barrier(s).

Deployment of the or each barrier onto or proximate to the wheel(s) is important to maximise the restraining force and/or minimise vehicle run-up distance to the barrier(s).

For example, when the or each barrier is deployed so as to be at or above axle height of the respective wheel(s) when suitably deployed, there is then no upward force by the barrier(s) on the respective wheel to assist the wheel(s) to climb over the barrier(s). Therefore, the or each barrier does not push the respective wheel upward.

The or each barrier may preferably be deployed at or above axle height so that the respective wheel is moving into the barrier(s) rather than over the barrier(s).

Also, when the respective barrier includes at least one roller (such as, for example, item 28 represented in the accompanying Figures) that bears against or otherwise contacts the wheel, any rotational traction forces that the wheel may generate (e.g. from front wheel drive, rear wheel drive or 4 WD vehicles to respective barriers) will not be effectively transferred to the barrier and the wheel(s) will be prevented from “climbing” over the barrier.

The system may include vehicle wheel characteristic detection means, which may include one or more of vehicle wheel diameter detection means, vehicle wheel radius detection means and/or vehicle wheel circumferential curvature detection means, or a combination of two or more thereof.

Detection of one or more of the aforementioned wheel characteristics may be used to deploy the barrier(s) to a height to suit a predetermined minimum deployment height for a given size or type of wheel.

For example, the barrier deployed height for a 13 inch wheel rim and associated tyre will be lower than the deployed barrier height for a 21 inch wheel rim and associated tyre.

Such vehicle wheel characteristic detection means may include detecting effective profile of the tyre on the tyre rim. Such tyre profile detection may include determining tyre profile at the base of the tyre (which is ‘squashed’ due to vehicle load applied through the tyre in contact with the ground surface), determining profile of the tyre at one or m ore other sections of the tyre, and determining effective radius, diameter or axle height, or a combination of two or more thereof, of a respective wheel. Deployment height of the barrier(s) can then be controlled to suit the determined size of the wheel.

Wheel size may be used as a factor to assist in determining likely vehicle power, and therefore in assessing potential force a vehicle may apply to a barrier if a drive away attempt is made against a deployed barrier. Therefore, resistance of the barrier to a force applied by the vehicle if a drive away attempt is made can be controlled.

For example, pressure applied by one or more said actuators deploying the respective barrier(s) may be reduced, maintained or increased depending on the anticipated or expected force a vehicle may be expected to assert against the barrier(s).

In the event of system failure with the barrier(s) deployed, an emergency or manual release means may be provided, such as, for example, a hydraulic or pneumatic pressure release means or mechanical release means.

In addition or alternatively, vehicle bodywork, components and/or chassis presence detection may be provided.

For example, one or more cameras and/or proximity sensors may be provided to detect that any commenced or intended deployment of the barrier(s) to an intended height might otherwise impact or risk damage to the vehicle body, components or chassis, and impact or damaged can be prevented by preventing, ceasing or modifying deployment of the barrier(s).

Modification of deployment of the barrier(s) may include altering an intended deployment height and/or modifying direction of deployment of the barrier(s).

For example, any mechanism of the system providing physical barrier deployment may have deployment angle adjustment, barrier deployment extension (deployment distance) adjustment and/or barrier deployment speed adjustment. Such adjustment(s) may be automatically controlled by the system based on the detected vehicle wheel characteristics and/or vehicle wheel position within the holding zone.

It will be appreciated that deployment of the or each barrier will preferably put the barrier(s) at a height at or above the axle position of the vehicle in the holding zone.

Whether the vehicle has its wheel(s) in a well or on a level surface within the holding zone, the or each barrier may be raised to the required height, and as described above, may preferably contact the wheel (such as contacting the surface of the tyre of the respective wheel) or be proximate thereto.

The or each barrier may be deployed to a minimum height of, for example, a radius of the wheel rim of the vehicle plus a profile (tyre side wall) height.

One or more embodiments of the present invention may provide a method of preventing vehicle drive away from a holding zone, the method including providing at least one roller within the holding zone, the at least one roller contacting the vehicle's powered wheels and rotating with rotation of the vehicle's powered wheels to prevent drive away of the vehicle from the holding zone.

Contact of the barriers with the surface of the wheel or respective wheels (e.g. surface either side of one wheel or surface of one wheel and the surface of another wheel) restrains the vehicle from any substantial forward or rearward movement.

The barriers may clamp one or more wheels of the vehicle e.g. by applying a positive holding force either to the tread surface of the tyre both front and rear with respect to the wheel on the vehicle, or by clamping against a leading surface of a front tyre and a trailing surface of a rear tyre, such that the vehicle is effectively held in the holding zone e.g. effectively clamping against the wheel or wheels. This aims to discourage a driver from attempting to move the vehicle because the vehicle is held firmly by the clamping force form the barriers, and optionally more discouraged if the barrier are also of the rotating (e.g. roller) type.

Positioning of the barrier or each of the barriers may include detecting pressure of the or each barrier against the surfacer of the tyre.

A respective barrier positioning apparatus may be provided to adjust position and or pressure of the respective barrier relative to and/or against the tyre.

For example, the actuator and/or device connecting the barrier to the actuator may be moveable, preferably moved by an adjuster device. Such adjuster device(s) may be concealed within a housing provided below the ground surface or within a housing of the system.

One or more visual and/or audible alerts may be provided to any person(s) near to or associated with the vehicle restrained in the holding zone by the actuated system and/or that the system is about to or is being deployed.

Such alerts may, for example, include one or more of pre-recorded messages, illuminated signage, alerts provided by authorised personnel (such as over a loudspeaker system), automated alerts provided to mobile devices, visual and/or audible alerts provided through equipment provided at or on a fuel bowser/pump.

One or more cameras may be employed to detect a characteristic of or associated with the vehicle, such as a vehicle license plate, and/or of the driver.

An image and/or license plate alphanumeric characters and/or visual features of the driver may be associated with the attempted drive away.

Fuel delivery on a subsequent occasion may be refused base don recognition of the vehicle and/or driver until prepayment is made. Such camera visualisation techniques may be integrated with the control means forming part of the system(s) and method(s) of embodiments of the present invention.

The at least one vehicle drive away preventer may be deployed by mechanical biasing means. The mechanical biasing means may include at least one spring.

The vehicle drive away preventer may be prevented from retraction by at least one retainer, preferably until the at least one retainer is released.

The at least one retainer may be released in association with operation of a vehicle drive away preventer retraction mechanism.

The drive away prevention system or apparatus may detect a direction of attempted drive away, and deploying the at least one vehicle drive away preventer to prevent vehicle drive away in that detected direction.

The drive away prevention apparatus may include at least one solid, mesh or framework panel providing a respective barrier to drive away movement of the vehicle when deployed.

The drive away prevention apparatus may include at least one biasing means, and release means, for effecting barrier deployment.

Wherein the release means includes at least one latch mechanism. The at least one latch mechanism may include at least one solenoid and/or cable operated mechanism.

Preferably the system or apparatus further includes at least one barrier deployment stop/limit means.

Preferably the system or apparatus includes at least one retainer preventing retraction of the respective barrier until released.

Preferably, the at least one retainer may be released by operation of a retraction mechanism for the at least one barrier.

### BRIEF DESCRIPTION OF THE DRAWINGS

One or more embodiments of the present invention will hereinafter be described with reference to the accompanying Figures, in which:

FIG. 1 shows a perspective view of a barrier and holding zone arrangement of a drive off prevention system according to an embodiment of the present invention.

FIG. 2 shows the holding zone and barrier arrangement of FIG. 1 in plan view.

FIG. 3a shows a side view of the holding zone and barrier arrangement of FIGS. 1 and 2, with activation rams and barrier retracted.

FIG. 3b shows the side view of FIG. 3a but with the rams and barriers extended.

FIG. 4 shows a partial section of the aforementioned holding zone and barrier arrangement, showing detail of the link device connected to the barrier member.

FIG. 5 shows a partial cross section of the aforementioned holding zone and barrier arrangement, showing detail of the actuator and link device to deploy the barrier member.

FIG. 6 shows a perspective view of a vehicle positioned within the holding zone and the barrier(s) deployed to prevent vehicle drive away.

FIG. 7a shows a side view general arrangement of an application of an embodiment of the present invention.

FIG. 7b shows a plan view of the holding zone with overhead sensor arrangement of FIG. 6.

FIGS. 8a and 8b show respective front and rear perspective views of a typical vehicle depicted at a service station/fuel bowser or pump and prevented from driving away by a deployed drive away prevention apparatus according to a further embodiment of the present invention.

FIGS. 9, 10 and 11 show side views (FIGS. 9 and 11 being a close-up partial side views) of a vehicle prevented from driving away by a deployed drive away prevention apparatus according to a further embodiment of the present invention.

FIGS. 12a, 12b and 12c show an embodiment of the drive away prevention apparatus with drive away preventers retracted (FIG. 12a) and deployed (FIG. 12b, 12c).

FIGS. 13 and 14 show internal arrangement and connection of components within a drive away prevention apparatus of an embodiment of the present invention.

FIGS. 15 and 16 show partial views of a drive away prevention apparatus revealing actuation and operational components of the drive away preventer (barrier) according to an embodiment of the present invention. FIG. 16 shows detail of a vehicle wheel (tyre) sensor, barrier release mechanism and retraction mechanism.

FIGS. 17 to 19 shows detail of a vehicle wheel sensor and barrier retraction cable adjustment mechanism.

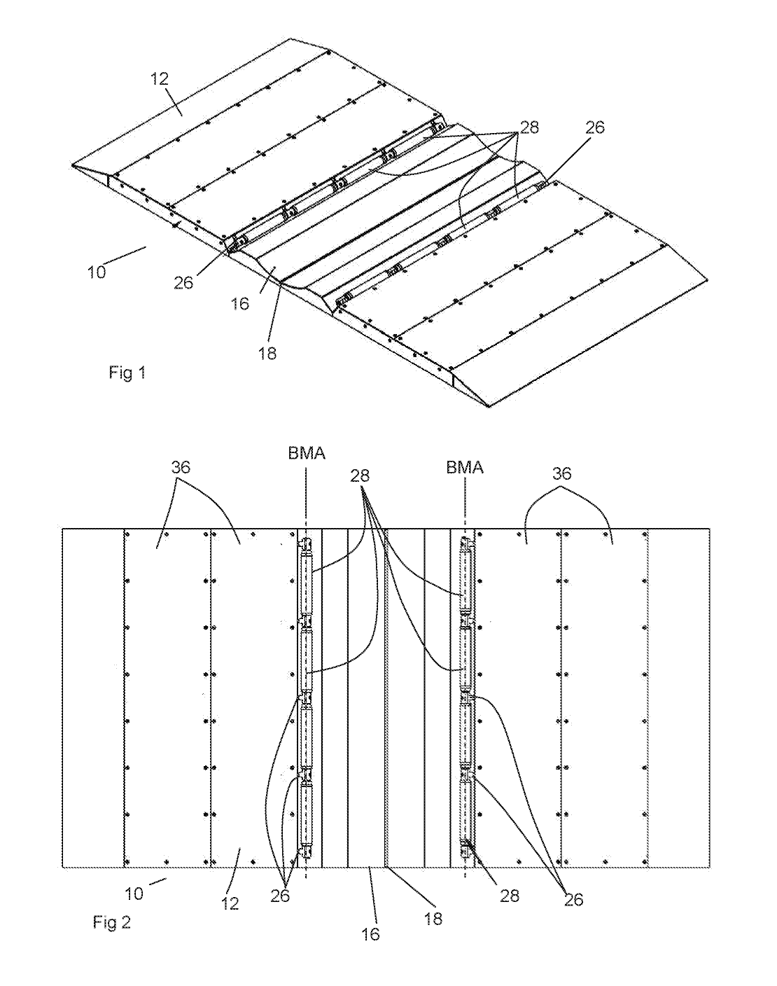

### DESCRIPTION OF PREFERRED EMBODIMENT(S)

A drive off prevention system 10 hereinafter described in relation to a service station (aka filling station) application.

It will be appreciated that embodiments of the present invention can be applied/installed at other locations than service stations to prevent unauthorised or controlled drive away, such as at security and customs/border checkpoints, onto and off ferries.

The system 10 provides a physical barrier arrangement actuated to prevent a vehicle from being driven away.

The barrier can be actuated to prevent drive away until fuel is paid for or the vehicle otherwise has authorisation to exit the barrier area.

The drive away prevention system 10 shown in the accompanying Figures includes a drive away prevention apparatus 11 having a support surface (such as a platform and/or an on/off ramp) 12 including at least one holding zone 14 incorporating at least one well 16.

At least one sensor 18 within or adjacent the respective well(s) detects presence of the wheel(s) 20 e.g. tyre 20a and/or wheel rim 20b, of the vehicle 42. Such sensing can:
i) allow the fuel pump to dispense fuel; and
ii) prime (arm) the barrier ready for deployment.

Such sensing may be by pressure sensing as the tyre rests within the respective well(s).

Alternatively or in addition, presence of the tyre and/or wheel rim can be by optical detection (such as by breaking a passive or active infra red light beam, inductive sensing of the presence of the metal wheel rim or metals belts within the tyre, Doppler sensing and/or camera visualisation and processing to detect movement of an identified feature on the wheel.

In the present specification, reference to the wheel of the vehicle includes reference to the tyre or to the rim supporting the tyre. That is, the tyre or the wheel rim may be detected, or weight of the vehicle through the rim and tyre may be detected.

A vehicle 42 driving onto the support surface stops with at least one wheel 20 within the well(s) of the holding zone 14.

It will be understood that the holding zone does not need to include one or more said wells. The physical barrier to prevent the vehicle being driven away can be provided to extend to bar/block movement of the wheel(s) of the vehicle at the ground surface.

Alternatively, the system of one or more embodiments of the present invention need not require a ramp. A vehicle can drive along level ground and stop within the holding zone on the support surface.

It will be appreciated that the system may include a well extending across at least part of a width of the holding zone so that a well receives adjacent wheels of the vehicle, such as a pair of front or rear wheels.

Alternatively, multiple wells 14 can be provided, such that, for example, each front or rear wheel is received into a well within the holding zone. The multiple wells can be adjacent one another, such as across a representative width of typical vehicles.

Such wells can be provided for front and rear wheels of the same vehicle. However, it is preferred that a single well is, or adjacent wells are, provided to receive the front or rear wheel(s) of a vehicle.

Preventing just one of the front or rear wheels of a vehicle from leaving the ramp is sufficient for the system to prevent a vehicle from being driven away.

It is preferred, however, that multiple wheels of the same vehicle are prevented from leaving the holding zone until the vehicle is authorised to leave, such as by payment for fuel received or otherwise deactivation of barrier deployment, such as by an operator.

In operation, a vehicle stops adjacent to a fuel pump. The fuel pump is preferably controlled to not dispense fuel until the vehicle properly has the required wheel(s) within the holding zone. For example, the driver may stop with the front wheels of the vehicle within the well(s) at the front of the vehicle. This ‘drop’ into the well(s) can be felt/sensed by the driver, thereby giving a physical indication that the vehicle is correctly within the holding zone.

If necessary, the vehicle can be guided to the correct position within the holding zone via signage. This may include visual indication(s), such as one or more lights and/or signs and/or audible indicators. Such indications can be controlled by the service station operator and/or be automatic upon detecting that a vehicle has approached and/or entered the holding zone.

Once the vehicle is correctly in the holding zone, the driver or associated person (such as a passenger from the vehicle) or a pump attendant, can operate the fuel pump to put fuel into the fuel tank of the vehicle (or, in the case of an electric vehicle, connect the vehicle to a supply of electricity for recharging).

It will be appreciate that operation of the fuel pump (or recharging point) can be linked to, or form part of, the drive away prevention system. In such arrangements, the pump will not dispense fuel to the next vehicle until the presence of that next vehicle is sensed and the barrier is primed for deployment to prevent unauthorised drive away.

With at least one wheel sensed to be correctly positioned within the holding zone, the barrier is primed ready to be deployed. At this point, the barrier need not actually be deployed. It will be appreciated that this ‘passive’ type of security system is more acceptable to service stations operators and to patrons of the service stations.

The system according to embodiments of the present invention removes the concern that the barrier will not deactivate once payment is made and otherwise risk damage to the vehicle or create anxiety or stress to the patron.

Providing payment for the fuel is made (or as otherwise authorised) before the vehicle is driven away, the barrier need not be deployed. This arrangement differs significantly from a positive, automatic barrier deployed once the vehicle is detected within the correct part of the holding zone and deactivated once payment is made.

The ‘passive’ operation nature of the drive away prevention system of one or more embodiments of the present invention is less obtrusive than a positive barrier system. Drivers obtaining and paying for fuel before driving away do not experience an actual barrier deployment.

For example, at least one embodiment of the drive-away prevention system can be barely noticeable to patrons due to discrete integration of the actuator and barrier components into a service station forecourt. Such integration can include, for example, disposing the barrier actuator(s) and barrier(s) at or below ground level or within a low profile housing.

In use, when the vehicle is sensed to be correctly within the holding zone, the fuel pump (or electrical charging point) can be activated and fuel can then be dispensed to the vehicle.

On completion of the required delivery of fuel, the barrier remains primed (armed) to deploy but is not at that point deployed.

Payment may be made at the fuel pump if post deliver payment at the pump is available. Alternatively, payment may be made at the service station counter or, if enabled, via wireless/internet banking from a mobile device.

Once payment is received, or as otherwise authorised by the service station operator, the barrier is deactivated (the system is disarmed) and the vehicle can be driven away form the holding zone to depart the service station.

If an attempt is made to drive the vehicle away from the holding zone without payment being made, the barrier is then deployed.

Barrier deployment can be activated by one or more sensors detecting that the vehicle wheel(s) has/have moved more than an allowed threshold or that the vehicle has moved to or beyond a threshold.

To detect vehicle movement, one or more sensors 22 can be provided near to or adjacent the well(s) and/or above or at the top surface of the support surface (such as the platform and/or ramp).

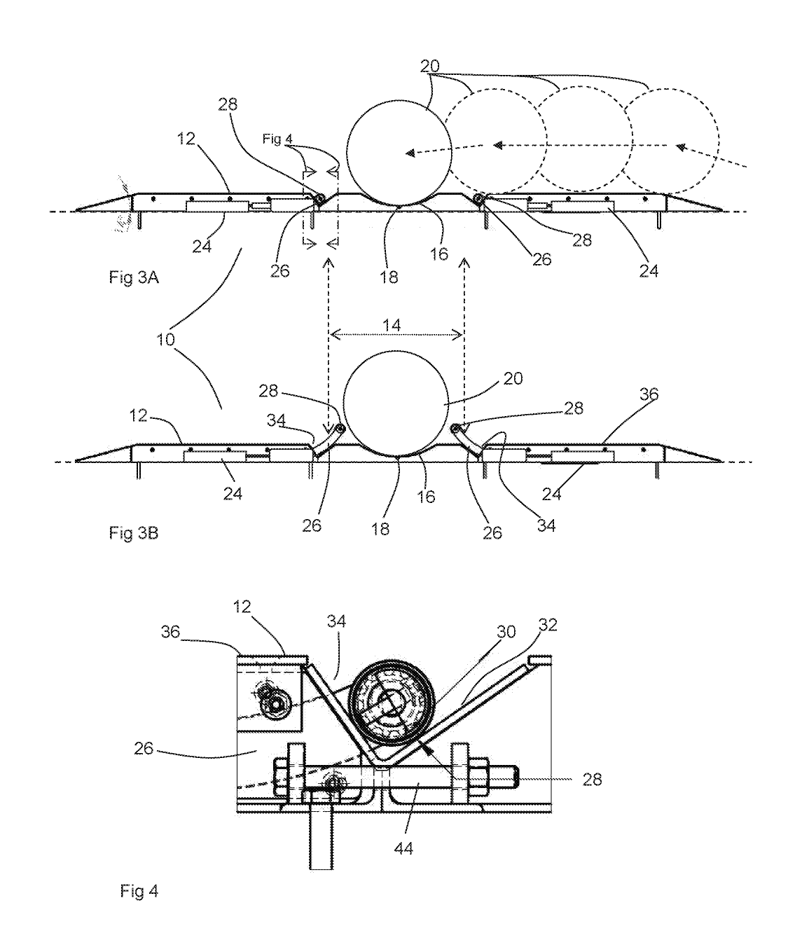

As shown in the accompanying FIGS. 3B and 4, the barrier is deployed by actuator rams 24 driving link devices 26 connected to barrier members 28 extending between and connecting the link devices 26 in front of or behind the wheel 20.

FIG. 3A shows a representation of a wheel 20 of the vehicle travelling onto the support surface 12 (e.g. the ramp) and stopping within the well 16 within the holding zone 14.

Each barrier member 28 can be connected between a respective pair of adjacent link devices 26 by a sprocket arrangement 30 at each link device end 32.

The sprocket arrangement can allow rotation of the barrier member during deployment and/or retraction of the link devices. For example, as the link devices are extended when the rams actuate, the barrier members may contact the surface 32 of the channel recess 34 within which the barrier members are retained when not deployed.

A removable cover 36 of the support surface may be provided to allow access to the respective rams thereunder.

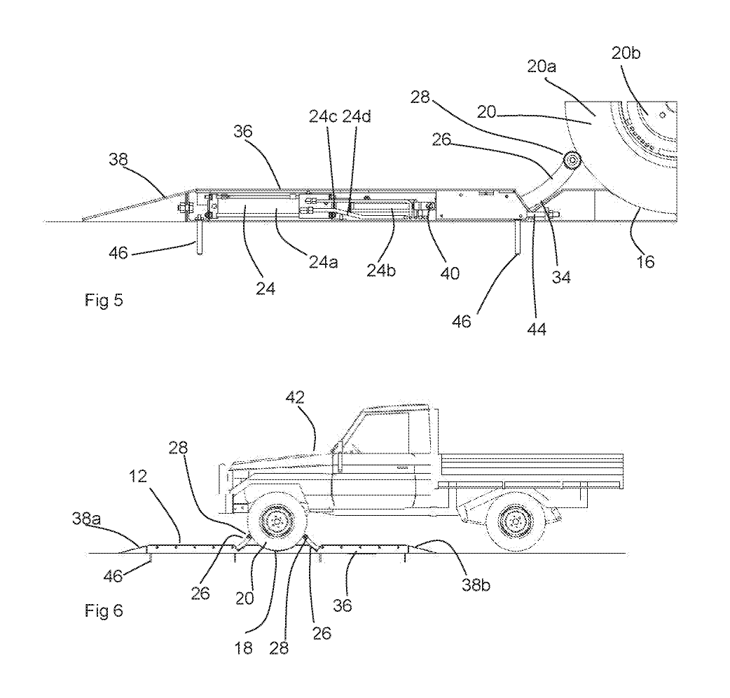

FIG. 5 shows a sectioned portion of the support surface 12 in a ground surface mounting installation. The support surface has a ramp incline 38 at each end (one end shown) of the support surface.

The actuator shown in FIG. 5 is a double acting ram 24 with a cylinder 24a and piston 24b. The piston is directly or indirectly operatively connected to the link device 26. It will be appreciated that multiple such rams can be provided to deploy and retract a barrier. Feed lines 24a, 24b provide hydraulic or pneumatic pressure to operate the ram(s).

The source of hydraulic or pneumatic pressure/power (such as a pump arrangement) can be incorporated below the support surface (such as in a well or pit below the support surface or forming a recess in the base of the support surface), or may be provided remotely with feed lines supply the operating pressure to the ram(s).

The link device 26 can be curved. Such curvature allows the link devices to extend outward and upward from a retracted position housed within the support surface to a deployed position with the barrier members at a height above the support surface in the manner shown, for example, in FIG. 5.

The support surface 16 can be formed of sections that connect together in order to tailor the length and width of the support platform, and therefore the size and position and number of holding zones to suit a particular application. As shown in detail in FIGS. 4 and 5, the sections are fastened together by releasable fasteners 44 (for example, bolt and nut fasteners). Any required number and combination of end ramp incline 38, well 16 section and normal support section can be connected to together to form the desired size of support surface.

It will be appreciated that the support surface can be or form a platform having the holding zone (such as having the well and deployable barrier arrangement). Such a platform can have an upper surface raised from the ground surface, such as by installing the platform onto the ground surface and fastening the base of the platform by fasteners 46 to the ground surface e.g. by ground anchors or bolts fastened into the ground.)

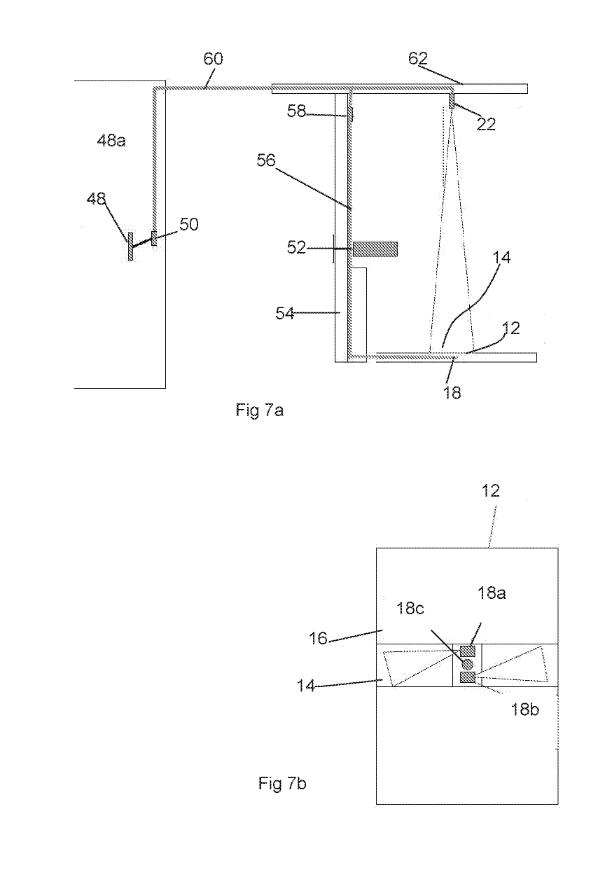

The side view general arrangement of an application of an embodiment of the present invention shown in FIG. 7a provides a display screen and control panel 48 operated by a service station operator at an operator service point 48a.

A controller 50 handles data communication between the display screen/control panel 48 and sensors 22,18 and indicator signs 52 relevant to the fuelling point 52.

The holding zone 14 is positioned near to a fuelling point 54 (e.g. fuel pump). One or more overhead sensors 22 monitor for vehicle distance and presence.

Sensors 18a,18b monitor safe zones 64. A first safe zone 64a is monitored within one side of the holding zone and a second safe zone 64b is monitored within a second side of the holding zone. Such sensors are preferably ultra sonic sensors to detect wheel distance. Therefore, if the vehicle wheel moves beyond a threshold amount, and payment for fuel has not been made, the system deploys the barrier(s).

An additional vibration sensor 18c provides vibration detection to determine whether the vehicle is moving or about to move. Detecting sufficient vibration exceeding a threshold amount can also cause the barrier(s) to deploy.

Processing within the controller or other processor can be can be used to determine whether a signal from only one of the sensors is required to deploy the barrier(s) or whether a number of signals is required before deploying the barrier(s).

The threshold for sufficient vehicle or vehicle wheel movement can be set as required.

For example, a forward or rearward movement of 50 mm or less can cause the system to deploy the barrier(s), preferably a movement distance of 20 mm or less, and more preferably of 15 mm or less.

The overhead sensor(s) 22 detects presence of the vehicle and can be used to determine that a vehicle is correctly positioned within the holding zone.

As shown in plan view in FIG. 7b, the holding zone 14 includes wheel distance sensors 18a,18b to detect distance movement of at least one wheel at each side of the vehicle.

A vibration sensor 18c detects vibration which can be used to determine presence of a vehicle or movement of the vehicle or likely movement of the vehicle. For example, if the engine of the vehicle starts up, the vibration sensor may detect sufficient vibration to pre-arm the barrier system that a drive away may be about to occur if fuel payment has not been made.

Pre-arming is preferably not required if payment has been made and no movement or vibration is sensed.

Pre-arming may include putting some initial pressure into the rams 24 sufficient to not commence movement of the barrier(s) but to avoid the need (and therefore delay) in initiating ram movement.]

According to one or more embodiments of the present invention, the barrier(s) can be deployed if sufficient vibration and/or thermal signature is/are detected and fuel payment has not been made.

In use, the system operates generally as follows. A service station patron drives a vehicle into the wheel well of the holding zone (aka a wheel ‘trap’). Sensors 18a,18b,18c detect that wheels are in wheel well. This detection allows an indicator to the driver (e.g. by a green light and sign saying “Ready to Fill” or wording to similar effect).

Either the operator/attendant arms the barrier system or the system is self arming, and turns on fuel pump/bowser. The patron is notified that the trap is armed through a red light and signage saying “Please see attendant before moving vehicle” (or wording to similar effect). The patron dispenses fuel into the vehicle and pays for the fuel. The barrier system is disarmed once payment is made, the red light/signage is turned off. The patron can then drive the vehicle away and exit the fuel station.

Alternatively, if the sensors (e.g. US (Ultrasonic) and IF (Infrared) Camera) determines the distance of objects in its field of vision. This will detect the movement of the vehicle by a difference distances with one measurement to another. The Infrared part of the camera determines that a vehicle is in the wheel well and not just a person with feet either side of the sensors. This is done by the heat reading being above a desired temperature, say, 50° C.

The vibration sensor(s) help to increase the accuracy of the detection by sensing that the engine of the car has been started. Vibration sensing can also be used by the attendant/operator to notify that a patron is attempting to dispense fuel while the vehicle's engine is running.

A warning or instruction to stop the engine can be given and/or fuel delivering can be shut-off.

Wheel sensing detects a wheel in the well, preferably sensing more than one wheel. Once the trap is armed the controller (PLC) will interrogate the camera periodically (e.g. every 10 ms) looking for definitive forward or rearward motion of the vehicle. Once sufficient movement has been detected, the controller will signal the barrier to be deployed.

To minimise cabling from the controller to the holding zone/trap a converter and controller 58 is used to for all communications of trap arming/disarming, vibration sensing, wheel sensing, driver indication lights etc.

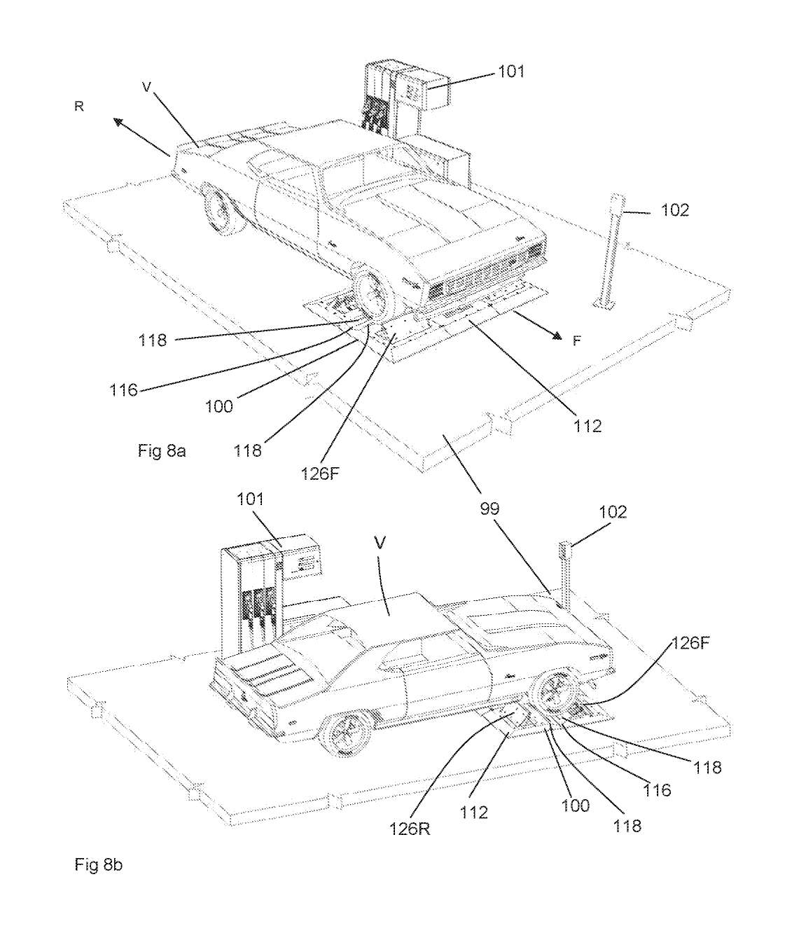

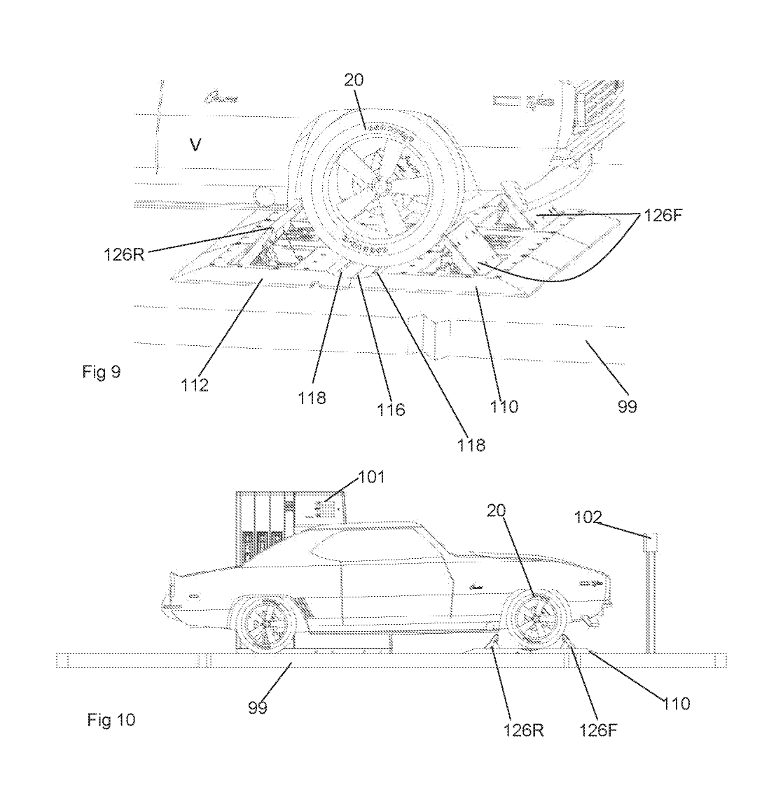

FIGS. 8a and 8b show an alternative embodiment of the present invention.

A drive away prevention apparatus 100 is shown with a vehicle V with each front wheel thereof within a respective well 116.

Sensors 118 detect the presence of one wheel or each wheel.

If the vehicle commences to move from the drive away prevention apparatus, the sensor(s) detect(s) movement of the wheel(s), and if one or more control conditions occur, such as non-payment of dispensed fuel, at least one barrier (drive away preventer) 126 is deployed.

For example, if the vehicle V attempts to rive forwards F, one or more forward barriers 126F deploy. If the vehicle attempts to move rearwards R, one or more rearward barriers 126R deploy.

Optionally, both forward and rearward barriers deploy regardless of the direction of attempted movement.

As shown in FIG. 9, the drive away prevent apparatus 100 can include a low profile platform 110 having a cover 112 over a baseplate or frame 114 (FIGS. 13 and 14).

The baseplate or frame 114 is preferably bolted to the ground 99 at a predetermined position, such as at a decided distance from a fuel bowser/pump set 101.

Controls, camera, communication and/or display device(s) 102 relating to the drive away prevention system/apparatus can be provided for use by an operator/attendant and/or user of the vehicle.

For example, voice communication may be provided for the user to communicate with the operator remotely, or a display providing information and/or instructions may be provided. Override and/or reset controls may also be provided, such as operator authorised code or key released controls.

The drive away prevent apparatus may be provided as a fix down apparatus with the base plate fixed to the ground 99 at a required position. Control and operation connections, such as electrical power, pneumatic/hydraulic actuation connections and/or data connections can be connected to the apparatus as required.

The cover can be attached over the actuation and control equipment mounted on the baseplate or frame 114.

Preferably the cover is or includes a resilient material, such as a rubber or rubberised material or a plastic material, such as polyurethane. The cover may be of coated metal, such as steel with a resilient coating or jacket applied thereto.

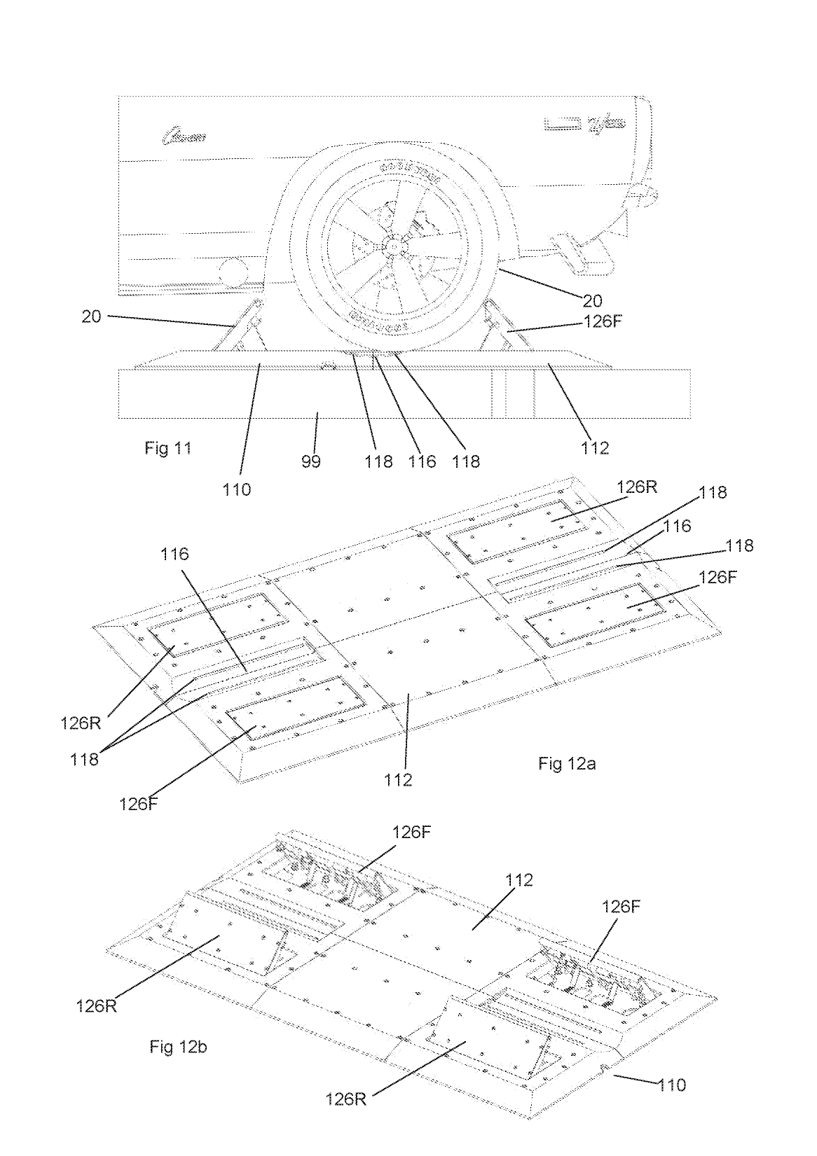

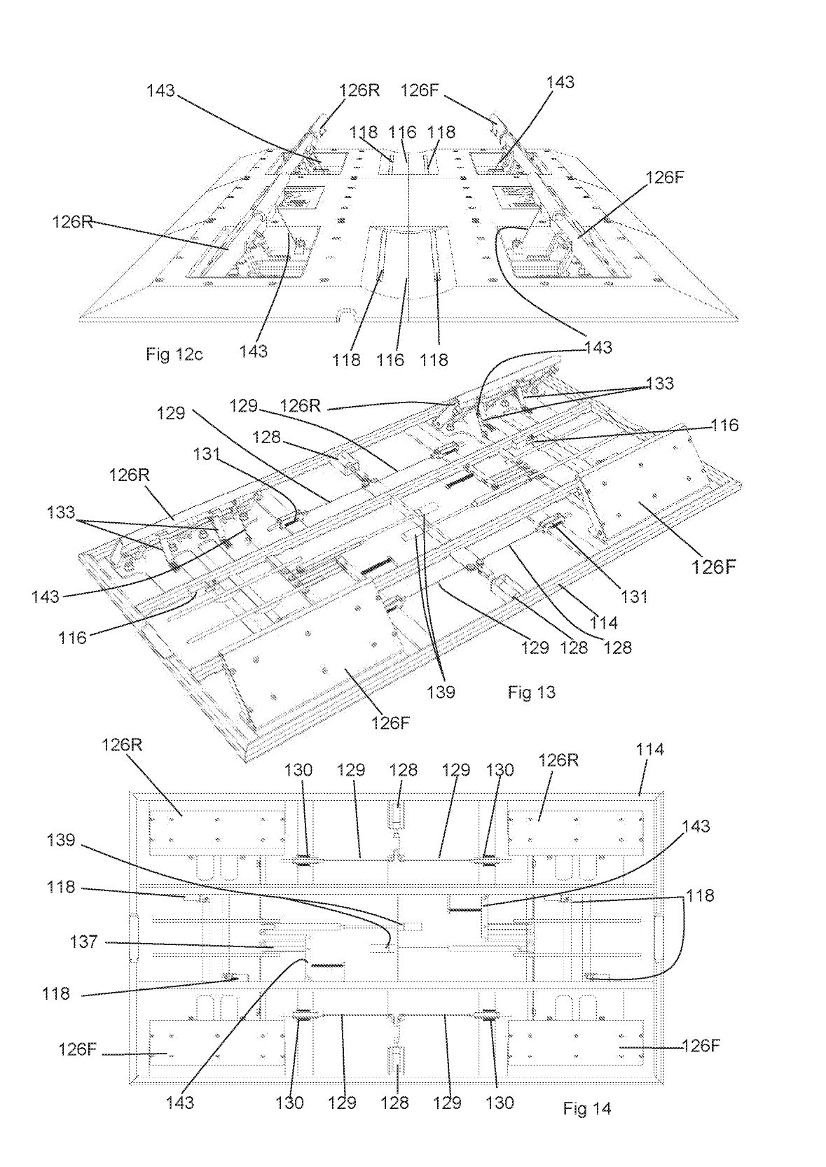

FIG. 12a shows an embodiment of the drive away prevention apparatus 100 with barriers 126 in the retracted (lowered) position, allowing a vehicle to drive on and off the platform 110 providing the barriers are not deployed.

FIGS. 12b and 12c show an example with the barriers 126 deployed without a vehicle in order to show hoe deployed position clearly or for testing.

FIGS. 13 and 14 show internal arrangement of components and connections for operating the drive away preventer 126 (126F and 126R).

Drive away preventers 126 (e.g. barriers) are deployed by operation of an electric solenoid 128 which pulls on a cable 128 attached to latches 130. Each latch 130 releases a respective drive away preventer which is then deployed by rotation about an pivot axis 132 by action of at least one spring 131.

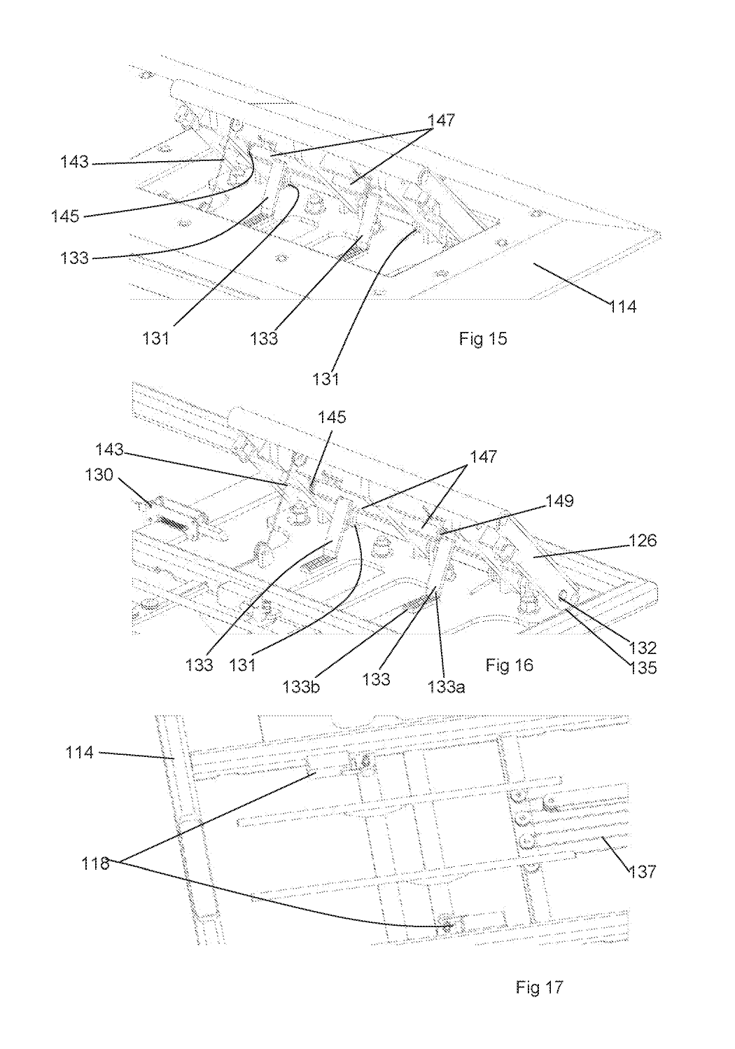

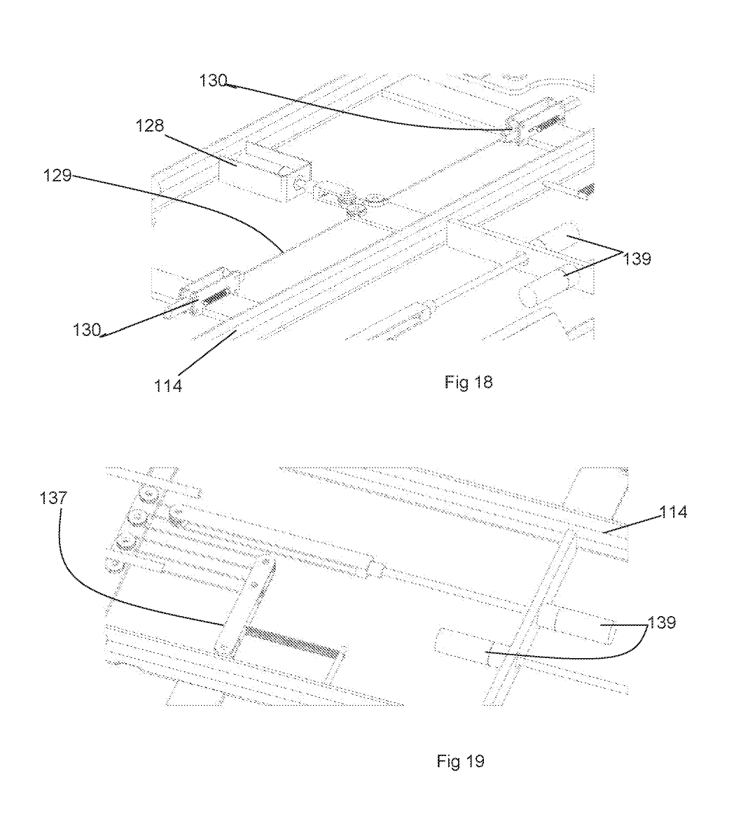

As shown in FIGS. 15 and 16, respective retainer mechanisms 133 prevent the drive away preventers 126 from returning to a retracted position until released.

Each retainer has a retainer piece 133a and a ratchet 132b into which the retainer piece slots at various positions to ensure that any downward pressure on the drive away preventer does not allow the drive away preventer to retract.

Each drive away preventer 126 is prevented from deploying beyond a required arc of rotation by a stop mechanism 135, which may preferably include a portion of one or more of the respective drive away preventers projecting beyond the pivot axis and contacting a stop once the drive away preventer has rotated upwards a required angle. This stop arrangement prevents a vehicle from forcing each drive away preventer further upwards and past vertical to allow the vehicle to depart.

FIG. 17 shows sensors 118 for detecting the presence, absence or attempted moving of a wheel of a vehicle.

FIG. 17 also shows detail of the cable slack adjuster mechanism 137 of the drive away preventer retraction mechanism 139.

When the deployed drive away preventers 126 are to be retracted (such as after a vehicle user has paid for fuel), actuators 141 of the retraction mechanism operate a respective cable 143 which rotates the shaft 132 to release the retainer pieces 133a against the retainer spring 131 biasing force, thereby allowing the cable to overcome the deployment spring 131 and retract the drive away preventer.

Operation of the cable 143 provides sufficient force to overcome the deployment spring biasing force that deployed the respective drive away preventer, causing the drive away preventers to retract back down into the platform.

The release latches 130 re-engage with the drive away preventers and hold them down against the spring biasing force until re-deployment is required.

1. A vehicle drive away prevention system including:
at least one vehicle drive away prevention apparatus to selectively allow the vehicle to leave a holding zone or prevent the vehicle from leaving the holding zone,
at least one detection means for detecting at least one parameter indicative of movement or anticipated movement of the vehicle within the holding zone, and
control means responsive to the at least one detection means to control operation of the vehicle drive away prevention apparatus to prevent the vehicle from leaving the holding zone when the at least one detection means detects the at least one parameter indicative of actual movement or anticipated movement of the vehicle.

2. The vehicle drive away prevention system of claim 1:
the vehicle drive away prevention apparatus including:
at least one barrier deployable to prevent the vehicle from leaving a holding zone,
at least one barrier actuator to deploy the at least one barrier,
at least one movement detection means to detect at least one parameter indicative of movement or anticipated movement of the vehicle within the holding zone, and
a control means to control the at least one actuator to deploy the at least one barrier,
the control means allowing the at least one barrier actuator to deploy the barrier to prevent the vehicle from leaving the holding zone when the at least one detection means detects the at least one parameter indicative of actual movement or anticipated movement of the vehicle.

3. The vehicle drive away prevention system of claim 1, wherein a control condition includes that the vehicle is to be prevented from leaving the holding zone.

4. The vehicle drive away prevention system of claim 1, wherein a control condition includes presence of at least one control condition signal or absence of the at least one control condition signal relating to non-payment of fuel prior to the vehicle attempting to leave the holding zone.

5. The vehicle drive away prevention system of claim 4, wherein the at least one control condition signal relates to one or more of a fuel payment system, fuel delivery control system indicating that fuel has not been paid for and the vehicle is to be prevented form leaving the holding zone.

6. The vehicle drive away prevention system according to claim 1, including at least one vehicle presence detection means to detect presence of the vehicle within the holding zone.

7. The vehicle drive away prevention system of claim 6, wherein the presence detection means enables at least one fuel delivery system to provide fuel for the vehicle.

8. The vehicle drive away prevention system of claim 6, wherein at least one vehicle presence sensor also acts as the respective at least one vehicle movement sensor.

9. The vehicle drive away prevention system according to claim 1, wherein the at least one barrier includes at least one barrier member deployable ahead of at least one wheel to prevent the vehicle driving forwards out of the holding zone, or at least one barrier deployable behind the at least one wheel of the vehicle to prevent the vehicle reversing out of the holding zone, or both the at least one barrier member deployable ahead of the at least one wheel to prevent the vehicle driving forwards out of the holding zone and the at least one barrier deployable behind the at least one wheel of the vehicle to prevent the vehicle reversing out of the holding zone.

10. The vehicle drive away prevention system according to claim 8, the holding zone including at least one well or recess for receiving a respective at least one wheel of the vehicle.

11. The vehicle drive away prevention system according to claim 1, wherein the at least one barrier actuator includes at least one biasing means, spring, pneumatic ram, hydraulic ram or electric actuator, or combinations of two or more thereof.

12. The vehicle drive away prevention system of claim 11, wherein the barrier actuator includes at least one link device connecting the respective actuator ram or electric actuator to at least one deployable barrier member.

13. The vehicle drive away prevention system according to claim 1, including a support surface including the holding zone.

14. The vehicle drive away prevention system of claim 13, the support surface provided as part of an assembly or unit for installation at a service station, the assembly or unit incorporating the at least one barrier actuator.

15. The vehicle drive away prevention system according to claim 1, the vehicle drive away prevention apparatus including at least one roller within the holding zone, the at least one roller arranged and configured to contact the vehicle's powered wheels and rotating with rotation of the vehicle's powered wheels to prevent drive away of the vehicle from the holding zone.

16. The vehicle drive away prevention system according to claim 1, the drive away prevention apparatus including at least one solid, mesh or framework panel providing a respective barrier to drive away movement of the vehicle when deployed.

17. The vehicle drive away prevention system according to claim 1, the drive away prevention apparatus including at least one biasing means, and drive away preventer release means, for effecting barrier deployment.

18. The vehicle drive away prevention system according to claim 17, wherein, barrier deployment is effected by release of the release means including at least one latch mechanism.

19. The vehicle drive away prevention system according to claim 18, wherein the at least one latch mechanism is solenoid and/or cable operated.

20. The vehicle drive away prevention system according to claim 17, including at least one barrier deployment stop/limit means.

21. The vehicle drive away prevention system according to claim 17, including at least one retainer preventing retraction of the respective barrier until released.

22. The vehicle drive away prevention system according to claim 21, the at least one retainer being released by operation of a retraction mechanism for the at least one barrier.

23. A vehicle drive away prevention method including:
employing at least one detection means to detect at least one parameter indicative of movement or anticipated movement of the vehicle within a holding zone,
operating a vehicle drive away preventer apparatus to prevent the vehicle from leaving the holding zone when the at least one detection means detects the at least one parameter indicative of actual movement or anticipated movement of the vehicle.

24. The method of claim 23, further including:
providing a deployable barrier;
detecting that the vehicle is attempting to depart from the holding zone;
deploying the barrier to prevent departure of the vehicle from the holding zone.

25. The method of claim 23, including preventing the vehicle from departing the holding zone when a condition to allow the vehicle to depart the holding zone has not been met or a condition to prevent the vehicle departing the zone has been met.

26. The method of claim 23, whereby the condition to allow the vehicle to depart the holding zone is payment for fuel or the condition to prevent the vehicle departing the holding zone is non-payment for fuel.

27. The method of claim 23, whereby detecting that the vehicle is attempting to depart the holding zone includes detecting movement or anticipated movement of the vehicle.

28. The method of claim 27, whereby the movement detection includes one or more of rotation of one or more wheels of the vehicle, forward or rearward movement of one or more wheels, body, chassis or ancillary components of the vehicle.

29. The method according to claim 25, whereby the condition to be met is provided from one or more of a fuel delivery control system or fuel payment system.

30. The method according to claim 23, whereby payment for fuel provided prevents deployment of the barrier.

31. The method according to claim 23, including deploying the at least one barrier ahead of at least one wheel to prevent the vehicle driving forwards out of the holding zone, or deploying the at least one barrier behind the at least one wheel of the vehicle to prevent the vehicle reversing out of the holding zone, or deploying both the at least one barrier member ahead of the at least one wheel to prevent the vehicle driving forwards out of the holding zone and deploying the at least one barrier behind the at least one wheel of the vehicle to prevent the vehicle reversing out of the holding zone.

32. The method according to claim 23, including sensing presence of the vehicle within the holding zone, such sensed presence enabling delivery of fuel to the vehicle.

33. The method according to claim 23, the at least one vehicle drive away preventer being deployed by mechanical biasing means.

34. The method according to claim 33, wherein the mechanical biasing means includes at least one spring.

35. The method according to claim 23, the vehicle drive away preventer prevented from retraction by at least one retainer until the at least one retainer is released.

36. The method according to claim 35, the at least one retainer released in association with operation of a vehicle drive away preventer retraction mechanism.

37. The method of claim 23, including providing at least one roller within the holding zone, the at least one roller contacting the vehicle's powered wheels and rotating with rotation of the vehicle's powered wheels to prevent drive away of the vehicle from the holding zone.

38. The method according to claim 23, including detecting a direction of attempted drive away, and deploying the at least one vehicle drive away preventer to prevent vehicle drive away in that detected direction.

39. The vehicle drive away prevention system according to claim 2, wherein the at least one barrier includes at least one barrier member deployable ahead of at least one wheel to prevent the vehicle driving forwards out of the holding zone, or at least one barrier deployable behind the at least one wheel of the vehicle to prevent the vehicle reversing out of the holding zone, or both the at least one barrier member deployable ahead of the at least one wheel to prevent the vehicle driving forwards out of the holding zone and the at least one barrier deployable behind the at least one wheel of the vehicle to prevent the vehicle reversing out of the holding zone.

40. The vehicle drive away prevention system according to claim 2, the holding zone including at least one well or recess for receiving a respective at least one wheel of the vehicle.

41. The vehicle drive away prevention system according to claim 2, the vehicle drive away prevention apparatus including at least one roller within the holding zone, the at least one roller arranged and configured to contact the vehicle's powered wheels and rotating with rotation of the vehicle's powered wheels to prevent drive away of the vehicle from the holding zone.

42. The method according to claim 27, including deploying the at least one barrier ahead of at least one wheel to prevent the vehicle driving forwards out of the holding zone, or deploying the at least one barrier behind the at least one wheel of the vehicle to prevent the vehicle reversing out of the holding zone, or deploying both the at least one barrier member ahead of the at least one wheel to prevent the vehicle driving forwards out of the holding zone and deploying the at least one barrier behind the at least one wheel of the vehicle to prevent the vehicle reversing out of the holding zone.

43. The method according to claim 24, including sensing presence of the vehicle within the holding zone, such sensed presence enabling delivery of fuel to the vehicle.

44. The method according to claim 24, including detecting an attempted drive away without paying for fuel, and deploying the at least one vehicle drive away preventer to prevent vehicle drive away.
